(19) United States
(12) Patent Application Publication
(10) Pub. No.: US 2019/0301488 A1
(43) Pub. Date: Oct. 3, 2019

(54) GAS PATH DUCT FOR A GAS TURBINE ENGINE

(71) Applicant: PRATT & WHITNEY CANADA CORP., Longueuil (CA)

(72) Inventors: David BATCH, Mississauga (CA); Esther LEUNG, Markham (CA)

(21) Appl. No.: 15/944,002

(22) Filed: Apr. 3, 2018

(51) Int. Cl. F04D 29/54; F01D 9/04; F04D 29/56

(52) U.S. Cl. CPC F04D 29/547; F01D 9/041; F05D 2240/127; F05D 2220/3216; F04D 29/56

(57) ABSTRACT

A gas path duct for a gas turbine engine comprises an gas path defined around a longitudinal axis between an inner shroud and an outer shroud. The gas path adapted to receive therein a variable-pitch vane mounted between the inner and outer shrouds. The variable-pitch vane adapted to be pivotable about a pivot axis extending across the gas path between an outer pivot point and an inner pivot point. A portion of at least one of the inner and outer shrouds defines a spherical surface having a concave shape facing the longitudinal axis and extending away from a corresponding one of the inner and outer pivot points. The spherical surface having a center positioned on the pivot axis and a radius equal to a distance, perpendicular to the longitudinal axis, between the longitudinal axis and the corresponding one of the inner and outer pivot points.

### TECHNICAL FIELD

The application relates generally to variable-pitch vanes and, more particularly, to a gas path duct for surrounding such variable vanes.

### BACKGROUND OF THE ART

Variable pitch-vanes, such as variable inlet guide vanes (VIGVs) extend between inner and outer shrouds of a gas path, such as is found in the inlet duct of a gas turbine engine. The vanes can be variably positioned in the duct by pivoting about a span axis, to affect the swirl in the duct. As each vane pivots about its span axis, a clearance gap between the vane's end and the shrouds can vary, which can lead to unwanted vane tip aerodynamic losses.

### SUMMARY

In one aspect, there is provided a gas path duct for a gas turbine engine, the gas path duct comprising an annular gas path defined around a longitudinal axis between an inner shroud and an outer shroud spaced radially outward from the inner shroud relative to the longitudinal axis, the annular gas path adapted to receive therein a variable-pitch vane mounted between the inner and outer shrouds, the variable-pitch vane adapted to be pivotable about a pivot axis extending across the gas path between an outer pivot point and an inner pivot point, the outer pivot point located along the outer shroud and the inner pivot point located along the inner shroud; and a portion of at least one of the inner and outer shrouds defining a spherical surface having a concave shape facing the longitudinal axis and extending away from a corresponding one of the inner and outer pivot points along a corresponding one of the inner and outer shrouds, the spherical surface having a center positioned on the pivot axis and a radius equal to a distance, measured along a line perpendicular to the longitudinal axis, between the longitudinal axis and the corresponding one of the inner and outer pivot points.

In another aspect, there is provided a gas turbine engine comprising an annular gas path defined around a longitudinal axis between an inner shroud and an outer shroud spaced radially outward from the inner shroud relative to the longitudinal axis; a plurality of variable-pitch vanes extending between the inner and outer shrouds, each one of the plurality of variable-pitch vanes pivotable about a pivot axis extending across the gas path between an outer pivot point located along the outer shroud and an inner pivot point located along the inner shroud, the plurality of variable-pitch vanes pivoting through a full range of angular positions between an open position and a closed position; and at least one of the inner and outer shrouds has a portion defining a spherical surface with a concave shape facing the longitudinal axis and extending away from a corresponding one of the inner and outer pivot points along a corresponding one of the inner and outer shrouds, the spherical surface having a center positioned on the pivot axis and a radius equal to a distance, perpendicular to the longitudinal axis, between the longitudinal axis and the corresponding one of the inner and outer pivot points.

In a further aspect, there is provided a variable vane assembly for a gas turbine engine comprising an annular gas path defined around a longitudinal axis between an inner shroud and an outer shroud spaced radially outward from the inner shroud relative to the longitudinal axis; a plurality of variable-pitch vanes extending between the inner and outer shrouds, each one of the plurality of variable-pitch vanes pivotable about a pivot axis extending across the gas path between an outer pivot point located along the outer shroud and an inner pivot point located along the inner shroud, the plurality of variable-pitch vanes pivoting through a full range of angular positions between an open position and a closed position; and at least one of the inner and outer shrouds has a portion defining a spherical surface with a concave shape facing the longitudinal axis and extending away from a corresponding one of the inner and outer pivot points along a corresponding one of the inner and outer shrouds, the spherical surface having a center positioned on the pivot axis and a radius equal to a distance, perpendicular to the longitudinal axis, between the longitudinal axis and the corresponding one of the inner and outer pivot points.

### DESCRIPTION OF THE DRAWINGS

Reference is now made to the accompanying figures in which:

FIG. 1 is a schematic cross-sectional view of a gas turbine engine;

FIG. 2 is a schematic cross-sectional view of a gas path duct of the gas turbine engine;

FIG. 2A is an isometric view of an inlet guide vane disposable in the gas path duct of FIG. 2;

FIG. 2B is a side view of the inlet guide vane of FIG. 2A; and

FIGS. 3A-3B are schematic cross-sectional views of the gas path duct of FIG. 2.

### DETAILED DESCRIPTION

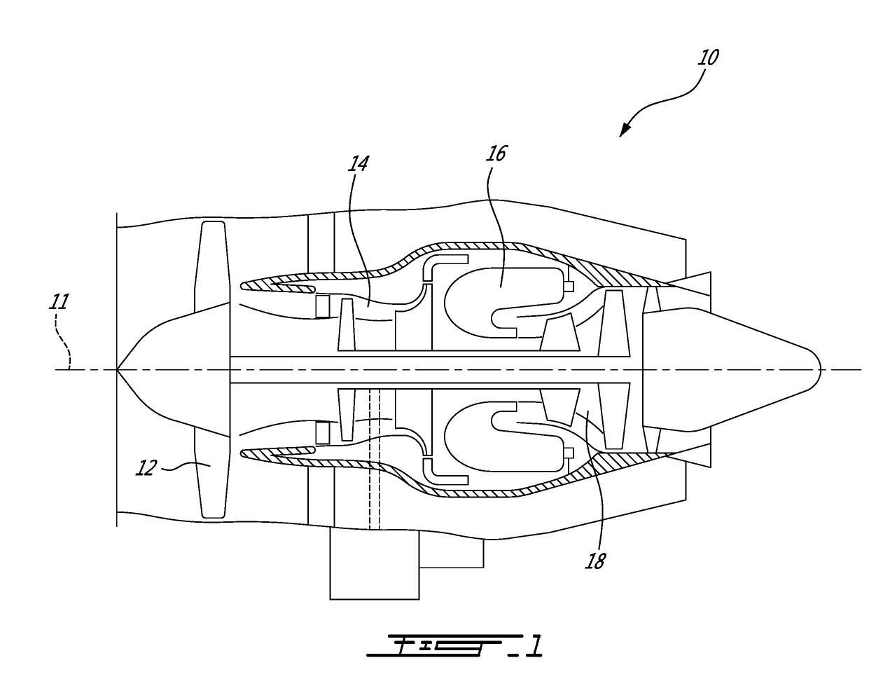

FIG. 1 illustrates a gas turbine engine 10 of a type preferably provided for use in subsonic flight, generally comprising in serial flow communication along a longitudinal axis 11 a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

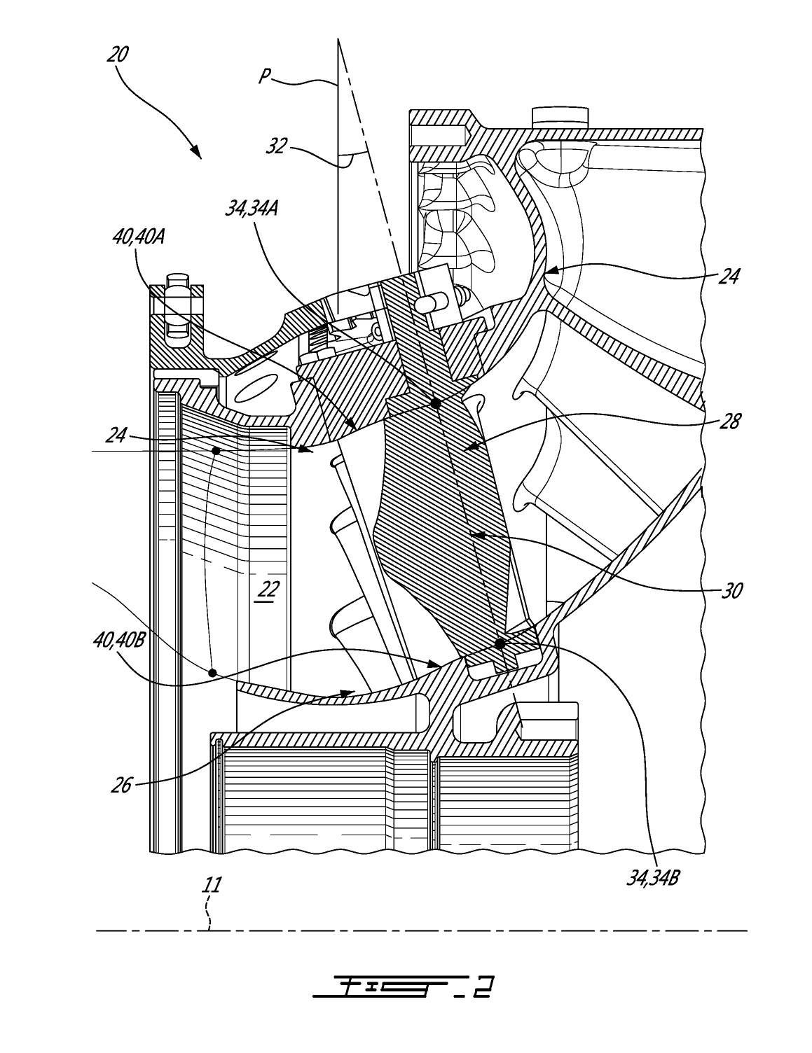

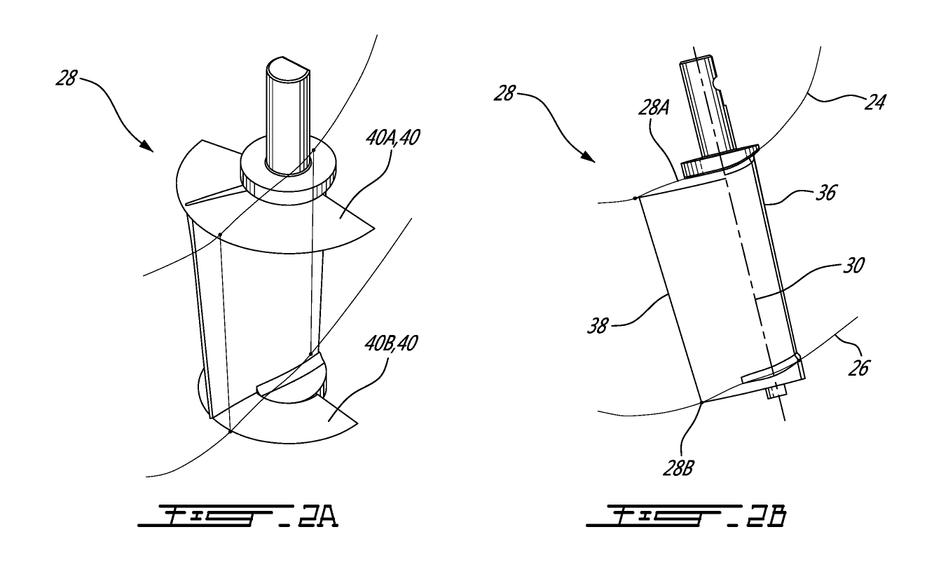

Referring to FIG. 2, a gas path duct 20 of the engine 10 is shown defining an annular gas path 22. The gas path duct 20 can direct an air flow into a compressor stage of the compressor section 14 through the gas path 22. The gas path duct 20 includes an outer shroud 24 and an inner shroud 26 extending along the longitudinal axis 11. The outer shroud 24 is spaced radially outward from the inner shroud 26 relative to the longitudinal axis 11. The outer shroud 24 defines a radially outer boundary of the gas path 22 and the inner shroud 26 defines a radially inner boundary of the gas path 22. The gas path duct 24 can refer to any other suitable ducts of the gas turbine engine 10.

For example, the compressor section 14 may include a plurality of variable-pitch vanes 28 disposed in the gas path duct 20. According to one example, the variable-pitch vanes 28 may be variable inlet guide vanes (VIGVs). However, although the variable-pitch vane 28 will be described below as an inlet guide vane 28, it is understood that variable-pitch vanes may be disposed in any suitable section of the gas turbine engine 10, and not necessarily at an inlet of the compressor or turbine stage.

The inlet guide vanes 28 are variable between multiple positions. That is, the inlet guide vanes 28 may rotate about a pivot axis 30 between a closed position and an open position. For example, the open position may refer to an angular position of zero degree (0 degree) relative to the longitudinal axis 11, and the closed position may refer to an angular position of sixty degrees (60 degrees). It is understood that other reference angular positions may be used to define the open and closed positions.

Referring to FIG. 2A, a full range of angular positions can be defined between the open and closed positions as shown. The inlet guide vane 28 may be positioned at any angular position thereof. As shown in FIG. 2A, the full range of angular positions may extend to a range of 180 degrees.

Referring back to FIG. 2, the pivot axis 30 extends across the gas path 22 between the outer and inner shrouds 24, 26 and may be inclined by a specific angle 32 with respect to a plane perpendicular P to the longitudinal axis 11. The inlet guide vane 28 rotates about the pivot axis 30 between an outer pivot point 34A and an inner pivot point 34B. The outer pivot point 34A is located at an intersection of the pivot axis 30 and the outer shroud 24 and the inner pivot point 34B is located at an intersection of the pivot axis 30 and the inner shroud 26. An upper end 28A of the inlet guide vane 28 is radially located toward the outer pivot point 34A and a lower end 28B of the inlet guide vane 28 is radially located toward the inner pivot point 34B. A radial clearance gap is defined on each side of the inlet guide vane 28. One clearance gap is defined between the upper end 28A and the outer shroud 24 and another clearance gap is defined between the lower end 28B and the inner shroud 26.

Referring to FIG. 2B, the inlet guide vane 28 is shown. The inlet guide vane 28 extends along a span between the lower end 28B and the upper end 28A and extends chordally between a leading edge 36 and a trailing edge 38. The pivot axis 30 may extend through cross-sectional centers of pressure of the inlet guide vane 28 along the span between the outer and inner pivot points 34A, 34B.

Referring to FIGS. 2-2B, one or more portions of the gas path duct 20 may define a spherical surface 40 opposite the inlet guide vane 28 to minimizes variations of the clearance gap during the pivoting of the inlet guide vane 28. The term “spherical surface” is intended to refer to a portion of a sphere and may differ slightly from being a perfectly spherical surface. For example, the outer shroud 24, the inner shroud 26, or both, may define a corresponding spherical surface 40 opposite the upper end 28A, the lower end 28B, or both. For example, one spherical surface 40A may be disposed opposite the upper end 28A and another spherical surface 40B may be disposed opposite the lower end 28B. The spherical surface 40 has a concave shape facing the longitudinal axis 11. The spherical surface 40 may have a shape that is complimentary in shape and in registry with one of the ends 28A, 28B of the inlet guide vane 28, or both, such that the radial clearance gap remains at least substantially constant through the full range of angular positions. It is understood that manufacturing tolerances, thermal expansions, and the like may affect the variation of the clearance gap. The constant variation of the clearance gap is intended to refer to the variation caused by the general shape of gas path ducts.

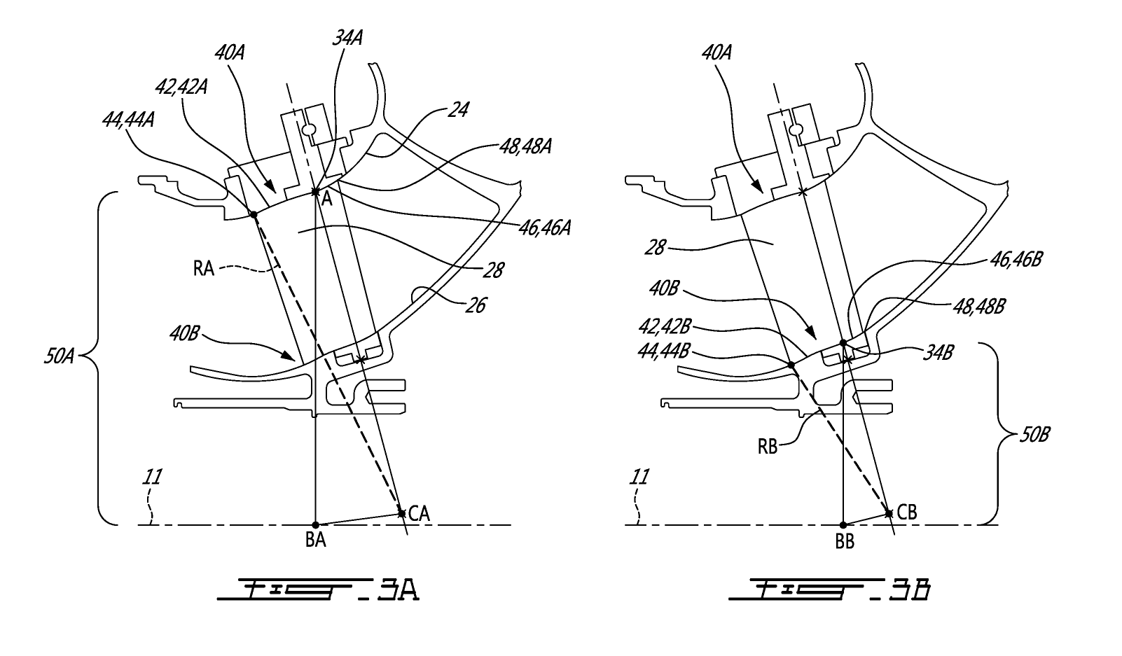

Referring to FIGS. 3A-3B, the spherical surface 40A of the outer shroud 24 extends away from the outer pivot point 34A along the outer shroud 24 (FIG. 3A) and the spherical surface 40B of the inner shroud 26 extends away from the inner pivot point 34B along the inner shroud 26 (FIG. 3B). The corresponding spherical surface 40 may extend downstream of the pivot axis 30, upstream of the pivot axis 30, or both, relative to a direction of the air flow, or gas flow, through the gas path 22. That is, in a longitudinal cross-sectional plane P of the gas path duct 20, where the longitudinal axis 11 lies in the longitudinal cross-sectional plane P, the spherical surface 40 has an arc 42 spanning from the pivot point 34 to a boundary point 44 downstream of the pivot point 34. The downstream boundary point 44 at least surrounds an end part of the trailing edge 38. Alternately, the spherical surface 40 may have an arc 46 spanning from the pivot point 34 to a boundary point 48 upstream of the pivot point 34. The upstream boundary point 48 at least surrounds an end part of the leading edge 36. Alternately, the spherical surface 40 may also have the arc 42 downstream of the pivot point 34 and the arc 46 upstream of the pivot point 34.

Referring more particularly to FIG. 3A, a distance between the upper pivot point 34A and the longitudinal axis 11 is shown as 50A. This distance 50A is perpendicular to the longitudinal axis 11. That is, the distance 50A is the shortest distance between the upper pivot point 34A and the longitudinal axis 11. The spherical surface 40A of the outer shroud 24 has a center CA positioned on the pivot axis 30. The radius RA of the spherical surface 40A, or the arc 42A, 46A, is equal to the distance 50A. Thus, line 44A-CA is equal to line 34A-BA. In operations, as the inlet guide vane 28 pivots about the pivot axis 30, the radial clearance gap between the outer shroud 24 and the upper end 28A of the inlet guide vane 28 is maintained constant, or substantially constant. For example, a clearance gap at the trailing edge 38 when the inlet guide vane 28 is in the open position, for instance at an angular position of zero degrees, will remain substantially the same when the inlet guide vane 28 rotates to the closed positions, for instance at an angular position of 90 degrees.

Referring more particularly to FIG. 3B, a distance between the lower pivot point 34B and the longitudinal axis 11 is shown as 50B. This distance 50B is perpendicular to the longitudinal axis 11. That is, the distance 50B is the shortest distance between the lower pivot point 34B and the longitudinal axis 11. The spherical surface 40B of the inner shroud 26 has a center CB positioned on the pivot axis 30. The radius RB of the spherical surface 40B, or of the arc 42B, 46B, is equal to the distance 50B. Thus, line 44B-CB is equal to line 34B-BA. In operations, as the inlet guide vane 28 pivots about the pivot axis 30, the radial clearance gap between the inner shroud 26 and the lower end 28B of the inlet guide vane 28 is maintained constant, or substantially constant. For example, a clearance gap at the trailing edge 38 when the inlet guide vane 28 is in the open position, such as at an angular position of zero degrees, will remain substantially the same when the inlet guide vane 28 rotates to the closed positions, such as at an angular position of 90 degrees.

The gas path duct 20 may have one or more spherical surfaces 40 around the longitudinal axis 11. As mentioned above, the spherical surface 40 may extend downstream of the pivot point 34, upstream of the pivot point 34, or both. The spherical surface 40 may be located only on the outer shroud 24, only on the inner shroud 26, or both. The spherical surface 40 may be designed with respect to the angle 32 of the pivot axis 30, the shape of the inlet guide vane 28, or both,

The above description is meant to be exemplary only, and one skilled in the art will recognize that changes may be made to the embodiments described without departing from the scope of the invention disclosed. For example, the gas path duct 20 may be located in the turbine section 18 of the gas turbine engine 10. Still other modifications which fall within the scope of the present invention will be apparent to those skilled in the art, in light of a review of this disclosure, and such modifications are intended to fall within the appended claims.

1. A gas path duct for a gas turbine engine, the gas path duct comprising:
an inner shroud and an outer shroud radially spaced-apart from each other defining an annular gas path having a longitudinal axis; and the annular gas path configured to receive therein a variable-pitch vane mounted between the inner shroud and the outer shroud for pivotal movement about a pivot axis, the pivot axis extending across the annular gas path between an outer pivot point on the outer shroud and an inner pivot point on the inner shroud, wherein a portion of at least one of the inner shroud and the outer shroud defines a spherical surface having a concave shape facing the longitudinal axis and extending away from a corresponding one of the inner and outer pivot points along a corresponding one of the inner shroud and the outer shroud, the spherical surface having a center positioned on the pivot axis and a radius equal to a distance from the longitudinal axis to the corresponding one of the inner pivot point and the outer pivot point, measured along a line perpendicular to the longitudinal axis.

2. The gas path duct as defined in claim 1, wherein, in a longitudinal cross-sectional plane of the gas path duct, the longitudinal axis lying in the longitudinal cross-sectional plane, the spherical surface has an arc spanning from the corresponding one of the inner pivot point and the outer pivot point to a boundary point downstream of the corresponding one of the inner pivot point and outer pivot point relative to a direction of flow through the annular gas path, the arc adapted to at least surround an end part of a trailing edge of the variable-pitch vane.

3. The gas path duct as defined in claim 1, wherein, in a longitudinal cross-sectional plane of the gas path duct, the longitudinal axis lying in the longitudinal cross-sectional plane, the spherical surface has an arc spanning from the corresponding one of the inner pivot point and the outer pivot point to a boundary point upstream of the corresponding one of the inner pivot point and outer pivot point relative to a direction of flow through the gas path, the arc adapted to at least surround an end part of a leading edge of the variable-pitch vane.

4. The gas path duct as defined in claim 1, wherein the pivot axis extends through centers of pressure of cross-sections of the variable-pitch vane along a span thereof between the inner shroud and the outer shroud.

5. The gas path duct as defined in claim 1, wherein the portion of at least one of the inner shroud and the outer shroud defines a first portion of the spherical surface disposed downstream of the outer pivot point relative to the direction of flow through the annular gas path and a second portion of the spherical surface disposed upstream of the outer pivot point relative to the direction of flow through the annular gas path.

6. The gas path duct as defined in claim 1, wherein the portion of at least one of the inner shroud and the outer shroud includes an outer portion of the outer shroud and an inner portion of the inner shroud, the outer portion having a first spherical surface downstream of the outer pivot point and the inner portion having a second spherical surface downstream of the inner pivot point relative to the direction of flow through the annular gas path, the first spherical surface having a first radius equal to a first distance, measured along a line perpendicular to the longitudinal axis, between the longitudinal axis and the outer pivot point and the second spherical surface having a second radius equal to a second distance, measured along a line perpendicular to the longitudinal axis, between the longitudinal axis and the inner pivot point.

7. A gas turbine engine comprising:
an inner shroud and an outer shroud radially spaced-apart from each other and defining therebetween an annular gas path extending around a longitudinal axis of the gas turbine engine;
a plurality of variable-pitch vanes extending between the inner shroud and the outer shroud, each one of the plurality of variable-pitch vanes pivotable about a pivot axis extending across the annular gas path between an outer pivot point located along the outer shroud and an inner pivot point located along the inner shroud, the plurality of variable-pitch vanes pivoting through a full range of angular positions between an open position and a closed position; and
at least one of the inner shroud and the outer shroud has a portion defining a spherical surface with a concave shape facing the longitudinal axis and extending away from a corresponding one of the inner and outer pivot points along a corresponding one of the inner and outer shrouds, the spherical surface having a center positioned on the pivot axis and a radius equal to a distance, measured along a line perpendicular to the longitudinal axis, between the longitudinal axis and the corresponding one of the inner pivot point and the outer pivot point.

8. The gas turbine engine as defined in claim 7, wherein, in a longitudinal cross-sectional plane of the annular gas path duct, the longitudinal axis lying in the longitudinal cross-sectional plane, the spherical surface has an arc spanning from the corresponding one of the inner pivot point and the outer pivot point to a boundary point downstream of the corresponding one of the inner pivot point and the outer pivot point relative to a direction of flow through the annular gas path, the arc surrounding an end part of a trailing edge of the variable-pitch vane.

9. The gas turbine engine as defined in claim 7, wherein, in a longitudinal cross-sectional plane of the annular gas path duct, the longitudinal axis lying in the longitudinal cross-sectional plane, the spherical surface has an arc spanning from the corresponding one of the inner pivot point and the outer pivot point to a boundary point upstream of the corresponding one of the inner pivot point and the outer pivot point relative to a direction of flow through the annular gas path, the arc surrounding an end part of a leading edge of the variable-pitch vane.

10. The gas turbine engine as defined in claim 7, wherein the pivot axis extends through centers of pressure of cross-sections of the variable-pitch vane along a span thereof between the inner shroud and the outer shroud.

11. The gas turbine engine as defined in claim 7, wherein the portion of at least one of the inner shroud and outer shroud define a first portion of the spherical surface disposed downstream of the outer pivot point relative to the direction of flow through the annular gas path and a second portion of the spherical surface disposed upstream of the outer pivot point relative to the direction of flow through the annular gas path.

12. The gas turbine engine as defined in claim 7, wherein the portion of at least one of the inner shroud and the outer shroud includes an outer portion of the outer shroud and an inner portion of the inner shroud, the outer portion having a first spherical surface downstream of the outer pivot point and the inner portion having a second spherical surface downstream of the inner pivot point relative to the direction of flow through the annular gas path, the first spherical surface having a first radius equal to a first distance, measured along a line perpendicular to the longitudinal axis, between the longitudinal axis and the outer pivot point and the second spherical surface having a second radius equal to a second distance, measured along a line perpendicular to the longitudinal axis, between the longitudinal axis and the inner pivot point.

13. The gas turbine engine as defined in claim 7, wherein the spherical surface has a shape complementary in shape to, and in registry with, an end part of at least one of the plurality of variable-pitch vanes such that a radial clearance gap defined between the spherical surface and the end part remains substantially constant through the full range of angular positions.

14. A variable vane assembly for a gas turbine engine comprising:
an annular gas path defined around a longitudinal axis between an inner shroud and an outer shroud spaced radially outward from the inner shroud relative to the longitudinal axis;
a plurality of variable-pitch vanes extending between the inner shroud and the outer shroud, each one of the plurality of variable-pitch vanes pivotable about a pivot axis extending across the gas path between an outer pivot point located along the outer shroud and an inner pivot point located along the inner shroud, the plurality of variable-pitch vanes pivoting between an open position and a closed position; and
at least one of the inner shroud and the outer shroud has a portion defining a spherical surface with a concave shape facing the longitudinal axis and extending away from a corresponding one of the inner pivot point and the outer pivot point along a corresponding one of the inner shroud and the outer shroud, the spherical surface having a center positioned on the pivot axis and a radius equal to a distance, measured along a line perpendicular to the longitudinal axis, between the longitudinal axis and the corresponding one of the inner pivot point and the outer pivot point.
